(19) United States
(12) Patent Application Publication
(10) Pub. No.: US 2026/0189786 A1
(43) Pub. Date: Jul. 2, 2026

(54) Systems, Methods, and Apparatuses for Phase Detection Autofocus (PDAF) Calibration Improvement and Lens Movement Compensation for Enhanced Autofocus Stability

(71) Applicant: Google LLC, Mountain View, CA (US)

(72) Inventor: Maximilian Michael Janke, Taipei City (TW)

(21) Appl. No.: 19/429,089

(22) Filed: Dec. 22, 2025

Related U.S. Application Data
(60) Provisional application No. 63/740,639, filed on Dec. 31, 2024.

(51) Int. Cl. H04N 23/67; H04N 23/68

(52) U.S. Cl. CPC H04N 23/672; H04N 23/675; H04N 23/687

(57) ABSTRACT

An example method includes receiving, by an image sensor of an image capture device, a pixel array corresponding to phase-detection pixels for a preview of a scene to be captured by the image capture device. The method also includes subdividing at least a portion of the pixel array into a plurality of sub-regions. The method additionally includes applying, based on a respective local signal strength associated with each of the plurality of sub-regions, a respective local defocus conversion coefficient (DCC) calibration. The method further includes predicting, by stacking the respective local signal strengths that have respective applied DCC calibrations, a defocus value for phase-detection autofocus (PDAF). The method also includes providing, based on the predicted defocus value, an adjustment to a lens position for the image capture device.

### CROSS-REFERENCE TO RELATED DISCLOSURE

This application claims priority to U.S. Provisional Patent Application No. 63/740,639, filed Dec. 31, 2024, which is incorporated herein by reference in its entirety.

### BACKGROUND

Many modern computing devices, including mobile phones, personal computers, and tablets, include image capture devices, such as still and/or video cameras. The image capture devices can capture images, such as images that include people, animals, landscapes, and/or objects. Such objects may appear at different depths in the image.

### SUMMARY

This application generally relates to improving phase-detection autofocus (PDAF) performance. The techniques described herein enable improved PDAF calibration by combining differently calibrated PDAF tiles.

In some approaches, PDAF performance may be improved by collecting more information at a pre-processing stage for image processing. This may be achieved by increasing exposure time and temporally stacking raw image data from multiple frames. Such an approach has the advantage that there is no information loss and the result is more accurate. However, in the event that the scene involves motion (e.g., movement of a subject in the scene, or a panning of the camera), the PDAF performance may be negatively impacted due to oversaturation, light leaks, and/or camera shaking. Also, for example, stacking raw image frames is likely to result in motion blur.

The techniques described herein can improve PDAF performance by calibrating similarity curves before disparity computation and sub-pixel interpolation and by using interpolation to stack the resulting possibly non-aligned similarity curves to form a unified curve.

In one aspect, a computer-implemented method is provided. The method includes receiving, by an image sensor of an image capture device, a pixel array corresponding to phase-detection pixels for a preview of a scene to be captured by the image capture device. The method also includes subdividing at least a portion of the pixel array into a plurality of sub-regions. The method additionally includes applying, based on a respective local signal strength associated with each of the plurality of sub-regions, a respective local defocus conversion coefficient (DCC) calibration. The method further includes predicting, by stacking the respective local signal strengths that have respective applied DCC calibrations, a defocus value for phase-detection autofocus (PDAF). The method also includes providing, based on the predicted defocus value, an adjustment to a lens position for the image capture device.

In another aspect, a computing device is provided. The device may include one or more processors. The device may also include data storage, where the data storage has stored thereon computer-executable instructions that, when executed by the one or more processors, cause the device to carry out operations. The operations may include receiving, by an image sensor of a camera of the computing device, a pixel array corresponding to phase-detection pixels for a preview of a scene to be captured by the camera. The operations may also include subdividing at least a portion of the pixel array into a plurality of sub-regions. The operations may additionally include applying, based on a respective local signal strength associated with each of the plurality of sub-regions, a respective local defocus conversion coefficient (DCC) calibration. The operations may further include predicting, by stacking the respective local signal strengths that have respective applied DCC calibrations, a defocus value for phase-detection autofocus (PDAF). The operations may also include providing, based on the predicted defocus value, an adjustment to a lens position for the camera.

In another aspect, an article of manufacture is provided. The article of manufacture may include a non-transitory computer-readable medium having stored thereon program instructions that, upon execution by one or more processors of a computing device, cause the computing device to carry out operations. The operations may include receiving, by an image sensor of an image capture device, a pixel array corresponding to phase-detection pixels for a preview of a scene to be captured by the image capture device. The operations may also include subdividing at least a portion of the pixel array into a plurality of sub-regions. The operations may additionally include applying, based on a respective local signal strength associated with each of the plurality of sub-regions, a respective local defocus conversion coefficient (DCC) calibration. The operations may further include predicting, by stacking the respective local signal strengths that have respective applied DCC calibrations, a defocus value for phase-detection autofocus (PDAF). The operations may also include providing, based on the predicted defocus value, an adjustment to a lens position for the image capture device.

In another aspect, a program is provided. The program, upon execution by one or more processors of a computing device, causes the computing device to carry out operations. The operations may include receiving, by an image sensor of an image capture device, a pixel array corresponding to phase-detection pixels for a preview of a scene to be captured by the image capture device. The operations may also include subdividing at least a portion of the pixel array into a plurality of sub-regions. The operations may additionally include applying, based on a respective local signal strength associated with each of the plurality of sub-regions, a respective local defocus conversion coefficient (DCC) calibration. The operations may further include predicting, by stacking the respective local signal strengths that have respective applied DCC calibrations, a defocus value for phase-detection autofocus (PDAF). The operations may also include providing, based on the predicted defocus value, an adjustment to a lens position for the image capture device.

In another aspect, a system is provided. The system may include means for carrying out the computer-implemented operations. The system may include means for receiving, by an image sensor of an image capture device, a pixel array corresponding to phase-detection pixels for a preview of a scene to be captured by the image capture device; means for subdividing at least a portion of the pixel array into a plurality of sub-regions; means for applying, based on a respective local signal strength associated with each of the plurality of sub-regions, a respective local defocus conversion coefficient (DCC) calibration; means for predicting, by stacking the respective local signal strengths that have respective applied DCC calibrations, a defocus value for phase-detection autofocus (PDAF); and means for providing, based on the predicted defocus value, an adjustment to a lens position for the image capture device.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

The patent or application on file contains at least one drawing executed in color. Copies of this patent or patent application publication with color drawings will be provided by the Office upon request and payment of the necessary fee.

FIG. 1 is an illustration of front, right-side, and rear views of a digital camera device, in accordance with example embodiments.

FIG. 2 is an example graphical representation for focus determination, in accordance with example embodiments.

FIG. 3 is an example illustration of focus determination for a larger region of interest (ROI), in accordance with example embodiments.

FIG. 4 is an example overview of a phase-detection autofocus (PDAF) pipeline, in accordance with example embodiments.

FIG. 5 is an example illustration of a PDAF pipeline, in accordance with example embodiments.

FIG. 6 is an example illustration of a modified PDAF pipeline, in accordance with example embodiments.

FIG. 7 is an example graphical illustration of two non-aligned local similarity curves, in accordance with example embodiments.

FIG. 8 is an example graphical illustration of interpolating two local similarity curves, in accordance with example embodiments.

FIG. 9A is an example illustration of focus determination based on ROI location, in accordance with example embodiments.

FIG. 9B is an example illustration of determining disparity based on ROI location, in accordance with example embodiments.

FIG. 10A is an example illustration of an existing approach to determining disparity, in accordance with example embodiments.

FIG. 10B is another example illustration of an existing approach to determining disparity, in accordance with example embodiments.

FIG. 11 is an example graphical illustration of sub-pixel interpolation, in accordance with example embodiments.

FIG. 12 is an example graphical illustration of interpolation prior to sub-pixel interpolation, in accordance with example embodiments.

FIG. 13A is an example illustration of determining zero-normalized cross-correlation (ZNCC) values, in accordance with example embodiments.

FIG. 13B is an example graphical illustration of stacked signal strengths, in accordance with example embodiments.

FIG. 14 is an example graphical illustration of possible losses from interpolation, in accordance with example embodiments.

FIG. 15 is an example graphical illustration of defocus conversion coefficient (DCC) stacking with ground truth data, in accordance with example embodiments.

FIG. 16 is an example graphical illustration of DCC stacking with a decreased target distance from a defocus value, in accordance with example embodiments.

FIG. 17 is an example illustration of local DCC calibration, in accordance with example embodiments.

FIG. 18 is an example graphical illustration of DCC stacking that aligns with the ground truth data, in accordance with example embodiments.

FIG. 19 is a block diagram of an example computing device, in accordance with example embodiments.

FIG. 20 is a flowchart of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### Overview

Existing approaches for defocus conversion coefficient (DCC) calibration have an inherent limitation in that they only apply one calibration function to the entire region of interest (ROI) instead of different calibration functions to multiple parts of the ROI. The term ROI as used herein, generally refers to a portion of an image with significant information (e.g., presence of an object of interest). Although some calibration methods interpolate between calibrations related to different parts of the ROI, only one calibration is finally applied. The disclosed techniques overcome these limitations of existing approaches. Different techniques may be applied for ROI detection in an image, such as, for example, edge detection, color segmentation, object detection, and so forth. ROIs may be used in a variety of applications such as object tracking, autonomous and/or semi-autonomous vehicles, medical imaging, robotics applications, optical character recognition, and so forth. Focusing properly on an ROI may be of high significance in accurate performance of such tasks.

An ROI may be associated with a signal strength based on image statistics (stats) such as, for example, an average brightness value of pixels that constitute the ROI, a maximum and/or minimum brightness value for such pixels, a number of pixels, values of red, green, blue (RGB) colored pixels, pixel index values for pixels in the ROI, and so forth. Additional and/or alternative signal strengths may be based on an area of the ROI, a mean pixel intensity in the ROI, a standard deviation of pixel intensity in the ROI, a hue, a saturation, a gray scale, a frequency distribution, an amount of texture, and so forth.

One significant challenge to effective PDAF calibration is lowlight. In some devices, camera autofocus employs temporal PDAF tile stacking to improve low-light performance and overall autofocus accuracy. However, current methods do not compensate for lens movement between frames, limiting the effectiveness of temporal stacking to situations where the lens does not move between frames, or where a slower lens convergence is acceptable. Lens movement between frames may likely cause a shift in similarity curves that optimally should be reversed before stacking. Such a correction is not currently applied. The shift may be exacerbated by a movement in ROI, which can also cause a shift. This can result in a distortion of the image. Although a DCC-calibration attempts to compensate for the shift, such a correction generally accounts for a single ROI. These effects can limit applicability of temporal stacking to enhance PDAF performance.

Another challenge arises when dealing with large Regions of Interest (ROIs) in the image. Existing PDAF calibration approaches correspond to a transformation applied to the phase difference output to compute the defocus value. This transformation typically depends on the image stats about the region of interest. A small ROI in one portion of the image may yield a different local transformation than an ROI in another portion of the image. If one considers a large ROI containing both these small ROIs, yet another global transformation may be applied that cannot always align with the local transformations. In one existing approach, the global transformation depends on the center of the ROI, thereby ignoring the calibration of the smaller ROIs. Other existing approaches interpolate calibrations based on a multitude of points in the ROI but overall they still result in one transformation independent of image content, thereby ignoring the different signal strength and/or relevance of the smaller ROIs. Generally, such approaches accord each of the smaller ROIs with an equal contribution, although there may be imbalances between the ROIs.

The techniques described herein solve this technical problem by performing DCC calibrations (e.g., calibrating similarity curves) before disparity computation and sub-pixel interpolation and by using interpolation to combine the resulting non-aligned similarity curves to form a unified curve. This approach improves PDAF calibration accuracy. Simulations have shown these techniques enable temporal PDAF tile stacking to compensate for lens movement, and allow for improved PDAF calibration on large Regions of Interest (ROIs) by applying different calibrations to different parts of the ROI.

### Example Camera Systems

As image capture devices, such as cameras, become more popular, they may be employed as standalone hardware devices or integrated into various other types of devices. For instance, still and video cameras are now regularly included in wireless computing devices (e.g., mobile devices, such as mobile phones), tablet computers, laptop computers, video game interfaces, home automation devices, and even automobiles and other types of vehicles.

The physical components of a camera may include one or more apertures through which light enters, one or more recording surfaces for capturing the images represented by the light, and lenses positioned in front of each aperture to focus at least part of the image on the recording surface(s). The apertures may be of a fixed size or may be adjustable. In an analog camera, the recording surface may be a photographic film. In a digital camera, the recording surface may include an electronic image sensor (e.g., a charge coupled device (CCD) or a complementary metal-oxide-semiconductor (CMOS) sensor) to transfer and/or store captured images in a data storage unit (e.g., memory).

One or more shutters may be coupled to, or positioned near, the lenses or the recording surfaces. Each shutter may either be in a closed position, in which it blocks light from reaching the recording surface, or an open position, in which light is allowed to reach the recording surface. The position of each shutter may be controlled by a shutter button. For instance, a shutter may be in the closed position by default. When the shutter button is triggered (e.g., pressed), the shutter may change from the closed position to the open position for a period of time, known as the shutter cycle. During the shutter cycle, an image may be captured on the recording surface. At the end of the shutter cycle, the shutter may change back to the closed position.

Alternatively, the shuttering process may be electronic. For example, before an electronic shutter of a CCD image sensor is “opened,” the sensor may be reset to remove any residual signal in its photodiodes. While the electronic shutter remains open, the photodiodes may accumulate charge. When or after the shutter closes, these charges may be transferred to longer-term data storage. Combinations of mechanical and electronic shuttering may also be possible.

Regardless of type, a shutter may be activated and/or controlled by something other than a shutter button. For instance, the shutter may be activated by a softkey, a timer, or some other trigger. Herein, the term “capture” may refer to any mechanical and/or electronic shuttering process that results in one or more images being recorded, regardless of how the shuttering process is triggered or controlled.

The exposure of a captured image may be determined by a combination of the size of the aperture, the brightness of the light entering the aperture, and the length of the shutter cycle (also referred to as the shutter length, the exposure length, or the exposure time). Additionally, a digital and/or analog gain (e.g., based on an ISO setting) may be applied to the image, thereby influencing the exposure. In some embodiments, the term “exposure length,” “exposure time,” or “exposure time interval” may refer to the shutter length multiplied by the gain for a particular aperture size. Thus, these terms may be used somewhat interchangeably, and should be interpreted as possibly being a shutter length, an exposure time, and/or any other metric that controls the amount of signal response that results from light reaching the recording surface.

In some implementations or modes of operation, a camera may capture one or more still images each time image capture is triggered. In other implementations or modes of operation, a camera may capture a video image by continuously capturing images at a particular rate (e.g., 24 frames per second) as long as image capture remains triggered (e.g., while the shutter button is held down). Some cameras, when operating in a mode to capture a still image, may open the shutter when the camera device or application is activated, and the shutter may remain in this position until the camera device or application is deactivated. While the shutter is open, the camera device or application may capture and display a representation of a scene on a viewfinder (sometimes referred to as displaying a “preview frame”). When image capture is triggered, one or more distinct payload images of the current scene may be captured.

Cameras, including digital and analog cameras, may include software to control one or more camera functions and/or settings, such as aperture size, exposure time, gain, and so on. Additionally, some cameras may include software that digitally processes images during or after image capture. While the description above refers to cameras in general, it may be particularly relevant to digital cameras. Digital cameras may be standalone devices (e.g., a DSLR camera) or may be integrated with other devices.

Either or both of a front-facing camera and a rear-facing camera may include or be associated with an ALS that may continuously or from time to time determine the ambient brightness of a scene that the camera can capture. In some devices, the ALS can be used to adjust the display brightness of a screen associated with the camera (e.g., a viewfinder). When the determined ambient brightness is high, the brightness level of the screen may be increased to make the screen easier to view. When the determined ambient brightness is low, the brightness level of the screen may be decreased, also to make the screen easier to view as well as to potentially save power. Additionally, the ambient light sensor's input may be used to determine an exposure time of an associated camera, or to help in this determination.

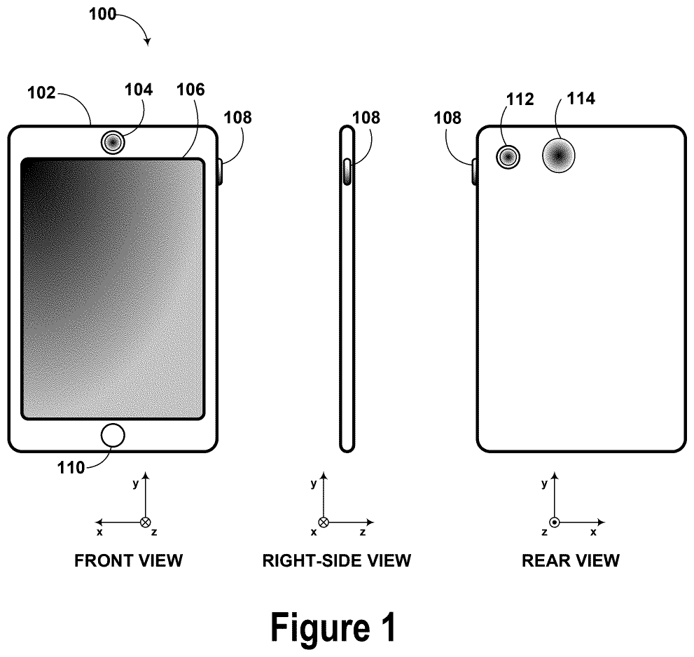

FIG. 1 is an illustration of front, right-side, and rear views of a digital camera device 100, in accordance with example embodiments. Digital camera device 100 may be, for example, a mobile device (e.g., a mobile phone), a tablet computer, or a wearable computing device. However, other embodiments are possible. Digital camera device 100 may include various elements, such as a body 102, a front-facing camera 104, a multi-element display 106, a shutter button 108, and other buttons 110. Digital camera device 100 could further include one or more rear-facing cameras 112, 114. Front-facing camera 104 may be positioned on a side of body 102 typically facing a user while in operation, or on the same side as multi-element display 106. Rear-facing cameras 112, 114 may be positioned on a side of body 102 opposite front-facing camera 104. Referring to the cameras as front-facing and rear-facing is arbitrary, and digital camera device 100 may include multiple cameras positioned on various sides of body 102.

Multi-element display 106 could represent a cathode ray tube (CRT) display, a light-emitting diode (LED) display, a liquid crystal display (LCD), a plasma display, or any other type of display known in the art. In some embodiments, multi-element display 106 may display a digital representation of the current image being captured by front-facing camera 104 and/or rear-facing cameras 112, 114, or an image that could be captured or was recently captured by either or both of these cameras. Thus, multi-element display 106 may serve as a viewfinder for either camera. Multi-element display 106 may also support touchscreen and/or presence-sensitive functions that may be able to adjust the settings and/or configuration of any aspect of digital camera device 100.

Multi-element display 106 may include additional features related to a camera application. For example, multiple modes may be available for a user, including, a motion mode, portrait mode, video mode, video bokeh mode, and so forth. The camera application may be in camera mode and provide additional features, such as a reverse icon to activate reverse camera view, a trigger button to capture a previewed image, and a photo stream icon to access a database of captured images. Also for example, a magnification ratio slider may be displayed and a user can move a virtual object along the magnification ratio slider to select a magnification ratio. In some embodiments, a user may use the multi-element display 106, also referred to herein as the display screen, to adjust the magnification ratio (e.g., by moving two fingers on display screen in an outward motion away from each other), and magnification ratio slider may automatically display the magnification ratio.

Front-facing camera 104 may include an image sensor and associated optical elements such as lenses. Front-facing camera 104 may offer zoom capabilities or could have a fixed focal length. In other embodiments, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent a monoscopic, stereoscopic, or multiscopic camera. Rear-facing cameras 112, 114 may be similarly or differently arranged. Additionally, front-facing camera 104, rear-facing cameras 112, 114, or both, may be an array of one or more cameras.

Either or both of front-facing camera 104 and rear-facing cameras 112, 114 may include or be associated with an illumination component that provides a light field to illuminate a target object. For instance, an illumination component could provide flash or constant illumination of the target object (e.g., using one or more LEDs). An illumination component could also be configured to provide a light field that includes one or more of structured light, polarized light, and light with specific spectral content. Other types of light fields known and used to recover three-dimensional (3D) models from an object are possible within the context of the embodiments herein.

In some digital camera devices 100, either or both of front-facing camera 104 and rear-facing cameras 112, 114 may include or be associated with an ambient light sensor that may continuously or from time to time determine the ambient brightness of a scene that the camera can capture. In some devices, the ambient light sensor can be used to adjust the display brightness of a screen associated with the camera (e.g., a viewfinder). When the determined ambient brightness is high, the brightness level of the screen may be increased to make the screen easier to view. When the determined ambient brightness is low, the brightness level of the screen may be decreased, also to make the screen easier to view as well as to potentially save power. Additionally, the ambient light sensor's input may be used to determine an exposure time of an associated camera, or to help in this determination.

Digital camera device 100 could be configured to use multi-element display 106 and either front-facing camera 104 or rear-facing cameras 112, 114 to capture images of a target object (e.g., a subject within a scene). The captured images could be a plurality of still images or a video image (e.g., a series of still images captured in rapid succession with or without accompanying audio captured by a microphone). The image capture could be triggered by activating shutter button 108, pressing a softkey on multi-element display 106, or by some other mechanism. Depending upon the implementation, the images could be captured automatically at a specific time interval, for example, upon pressing shutter button 108, upon appropriate lighting conditions of the target object, upon moving digital camera device 100 a predetermined distance, or according to a predetermined capture schedule.

As noted above, the functions of digital camera device 100 (or another type of digital camera) may be integrated into a computing device, such as a wireless computing device, cell phone, tablet computer, laptop computer, and so on. For example, a camera controller may be integrated with the digital camera device 100 to control one or more functions of the digital camera device 100.

### Example Phase-Detection Autofocus (PDAF) Pipelines

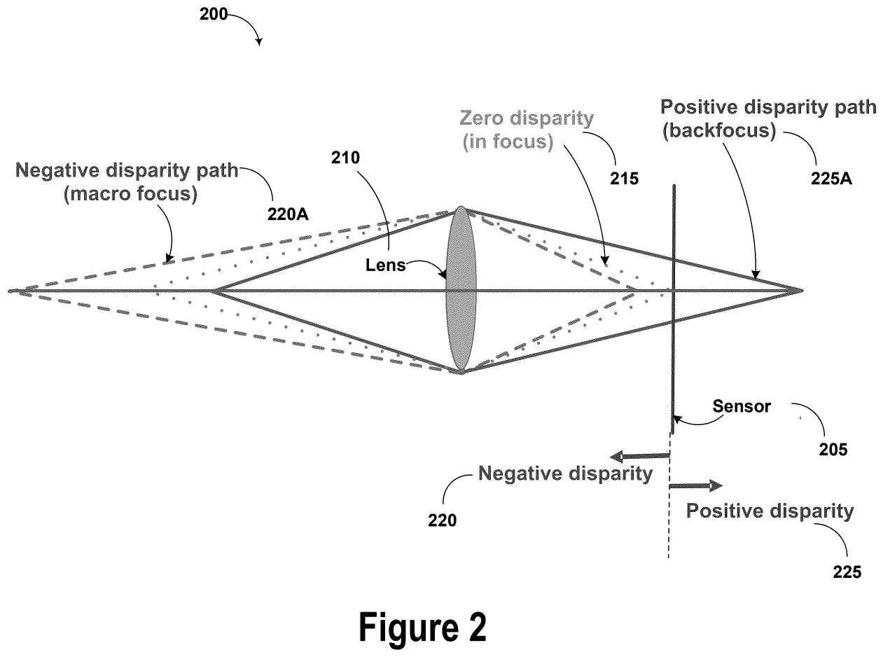

FIG. 2 is an example representation 200 for focus determination, in accordance with example embodiments. An image sensor 205 receives light from a lens 210. First curve 215 illustrates how the light can pass through lens 210 and be incident on the image sensor 205. In this situation, there is zero disparity, as the image is in focus. However, the light can pass through lens 210 and not be incident on the image sensor 205. This may occur in two ways. For example, as negative disparity path 220A illustrates, the light may fall short of sensor 205. In this situation, there is a negative disparity 220 (e.g., the image may be in macro focus). The second situation is illustrated by positive disparity path 225A. For example, as positive disparity path 225A illustrates, the light may fall beyond sensor 205. In this situation, there is a positive disparity 225 (e.g., the image may be in backfocus). In the situation of positive or negative disparities, a defocus conversion coefficient (DCC) calibration may be performed to adjust a position of lens 210 so that the light incident on the sensor 205 has zero disparity, resulting in an image that is in focus.

PDAF calibration corresponds to a transformation applied to the phase difference output to compute the defocus value. This transformation typically depends on the signal strength (e.g., image stats) of the ROI. A small ROI in the left side of the image yields a first transformation and a small ROI in the right side yields a second transformation. If one considers a large ROI containing both these small ROIs, a third transformation is applied that may not align with the first and second transformations. The third transformation generally depends on the center of the ROI, and can neglect the calibration of the left and right ROIs.

An inherent limitation of existing approaches is that they only apply one calibration function to the whole ROI instead of many calibration functions to multiple parts of the ROIs. Although some calibration methods may involve interpolating between calibrations related to different parts of the ROI, these methods ultimately rely on applying a single calibration to the entire region.

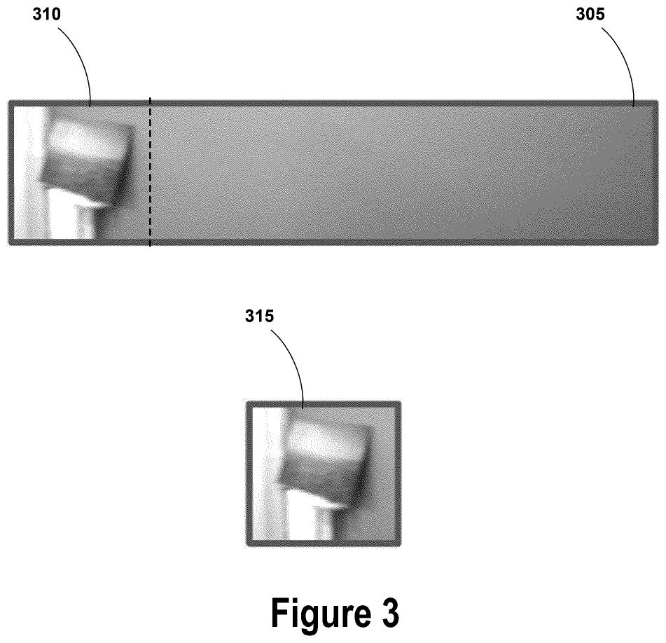

FIG. 3 is an example illustration of focus determination for a larger region of interest (ROI), in accordance with example embodiments. Two images with approximately similar results are shown. The DCC calibration may differ a lot, since the calibration depends on the center of the ROI. For example, a large ROI 305 is shown with a smaller local ROI 310. Existing approaches to DCC calibration involve computing a single disparity for ROI 305. Generally, such approaches focus attention at a center of ROI 305, which may then fail to focus on the details in local ROI 310. Another approach may be to perform DCC calibrations for sub-regions, including local ROI 310, and then average the local DCC calibrations. However, most of ROI 305 outside local ROI 310 is unremarkable. Accordingly, the centered DCC calibration, as well as the averaging approach, assign undue weight to the unremarkable portion of ROI 305 outside the local ROI 310. An accurate DCC calibration would involve focusing attention on region 315 so as to highlight the features present therein.

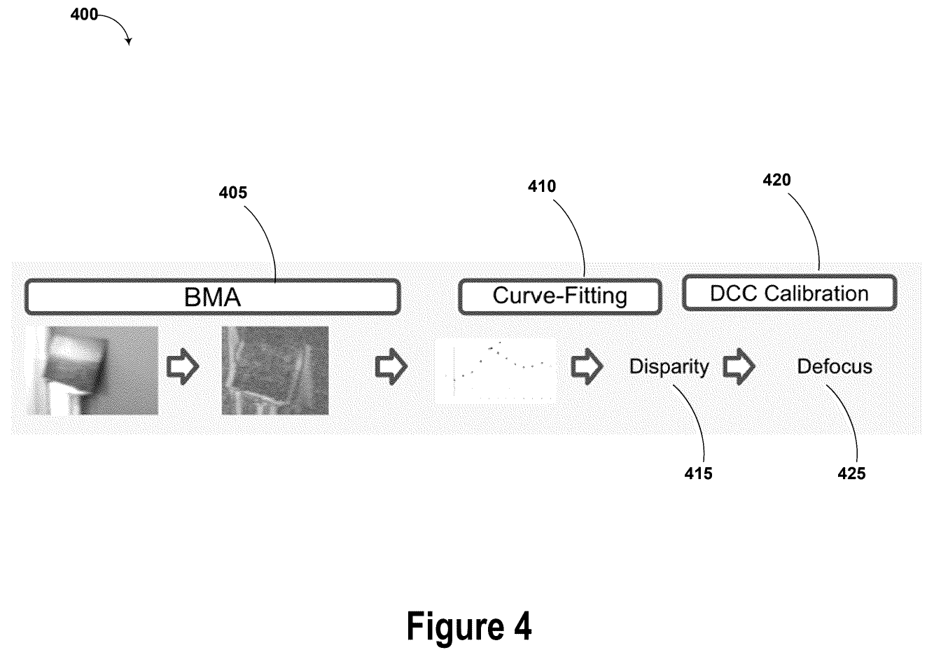

FIG. 4 is an example overview of a phase-detection autofocus (PDAF) pipeline 400, in accordance with example embodiments. The existing PDAF pipeline involves generating a similarity curve, performing subpixel interpolation to compute disparity (or phase difference), and then applying a DCC-calibration to obtain a defocus value, which, along with lens position, yields the target position.

For example, a block matching algorithm (BMA) 405 may be used to determine disparities between left and right images (e.g., phase-detection (PD) pixels). Based on these images, BMA 405 computes how to move the lens for optimal focus, the defocus value 425. Generally, one or more steps may be performed. For example, the BMA 405 may compare different shifts of the PD images to provide a similarity curve. Based on this similarity curve, curve-fitting 410 may compute a disparity 415. This disparity then leads to a defocus value 425 via DCC calibration. For example, DCC calibration 420 may involve using disparity 415 to predict defocus value 425. The predicted defocus value 425 may be used to adjust a lens position (e.g., lens 210 of FIG. 2) for a camera to achieve zero disparity (e.g., zero disparity 215 of FIG. 2).

A first observation is that the DCC calibration and curve-fitting may be interchangeable. Also, for example, calibration may be applied first to the (e.g., x-axis of) the similarity curve. Subsequently, curve-fitting may be used to obtain the defocus value. Also, for example, an ROI can be subdivided into tiles prior to applying the BMA. The BMA will provide a similarity curve for each tile (e.g., each similarity consists of a denominator and a numerator). These curves may then be stacked to form a single curve. Such an approach may generally provide the same defocus value.

Tiling the image data may provide several advantages. For example, at the hardware level, the original ROI may be the entire image frame with an appropriate tiling. These image frames may be spatially stacked to obtain other ROIs. Since the BMA is an expensive operation, many subregions of the ROI may be determined and evaluated simultaneously by tiling and then trying out different stackings. In terms of temporal stacking, the tiles may be stacked more easily. Also, for example, in the event the lens position does not change between image frames, tiles may be combined between these image frames.

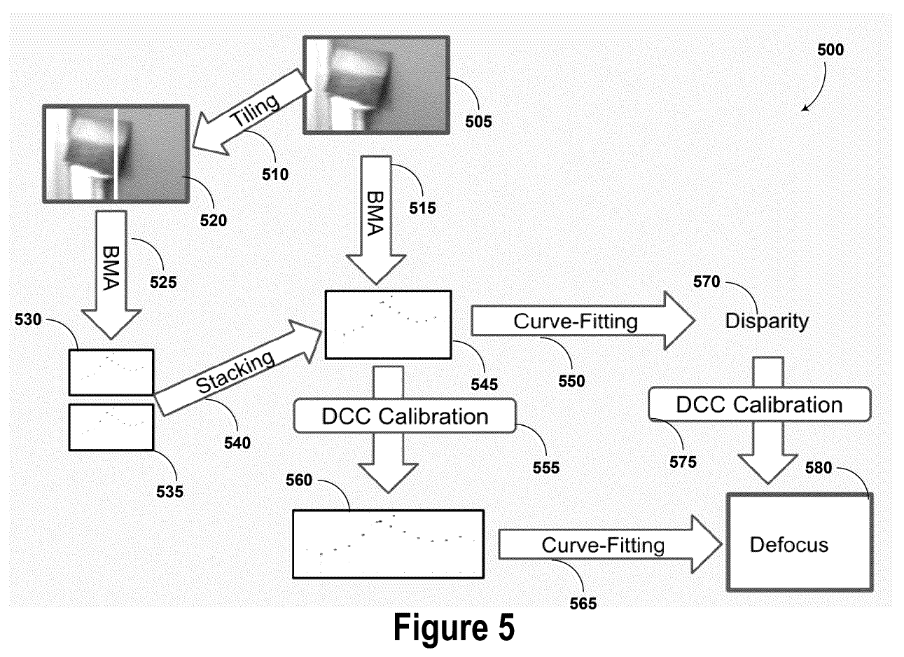

FIG. 5 is an example illustration of a PDAF pipeline 500, in accordance with example embodiments. For example, a first approach involves taking the image data 505 and applying a first BMA 515. A single similarity curve 545 may be determined based on the first BMA 515. A first curve fitting 550 may be applied directly to single similarity curve 545 and a disparity 570 may be determined based on a DCC calibration 575 to predict the defocus value 580.

In a second approach, tiling 510 may be performed on the image data 505 in an image sensor. A second BMA 525 may be applied to the tiled image data 520. One or more similarity curves, such as first curve 530 and second curve 535, one for each tile of tiled image data 520, may be generated. Also, for example, a single similarity curve 545 may be determined by aggregating the one or more similarity curves, such as first curve 530 and second curve 535. In some embodiments, DCC calibration 555 may be applied to obtain curve 560, and curve fitting 565 may be applied to predict the defocus value 580. Generally, the same defocus value 580 may be obtained based on the two approaches.

Simulations have shown that the techniques described herein, which integrate PDAF calibration into disparity computation and sub-pixel interpolation, and apply calibration prior to tile stacking, significantly improve PDAF calibration accuracy, enable temporal stacking even with lens movement, and can address the challenges associated with large ROIs.

### Example Modified Phase-Detection Autofocus (PDAF) Pipelines

One aspect of the techniques described herein modifies the existing PDAF pipeline 500 by applying local DCC-calibrations prior to subpixel interpolation. This enables the association of each similarity curve (e.g., first curve 530 and second curve 535) with a target position, thereby allowing subpixel interpolation to directly output a target position (e.g., predicted defocus value 580). Another aspect of the techniques described herein leverages multiple similarity curves (e.g., first curve 530 and second curve 535), each with its own DCC-calibration and lens position. This is particularly beneficial in temporal stacking. For example, in the event the lens is moving between frames, each frame may be associated with a respective lens position. Additionally, for large ROIs, the large ROI may be subdivided into smaller tiles, each with its respective similarity curve and tailored DCC-calibration. In some embodiments, interpolation techniques may be applied to stack similarity curves with different DCC-calibrations. By interpolating the constituent values of the similarity measure, similarity values can be obtained for each target position. Generally, although several local calibrations may be determined for different ROIs, only one calibration is applied to the PD pixels.

Also, for example, a maximum for curve-fitting may be determined. This can typically occur at a target position present after applying a DCC-calibration. Accordingly, only a few values need to be considered. Subsampling the similarity curve and applying standard subpixel interpolation enables application of a curve-fitting process while achieving good results. More advanced curve-fitting solutions may be applied for improved results. Alternatively, a main similarity curve may be fixed, and other curves may be interpolated by adding to the points of the main similarity curve. This enables a simpler implementation with negligible performance differences. The tailored calibration for each tile can enhance overall calibration accuracy. Applying calibration prior to stacking allows for temporal stacking even with lens movement, improving low-light performance and overall autofocus accuracy.

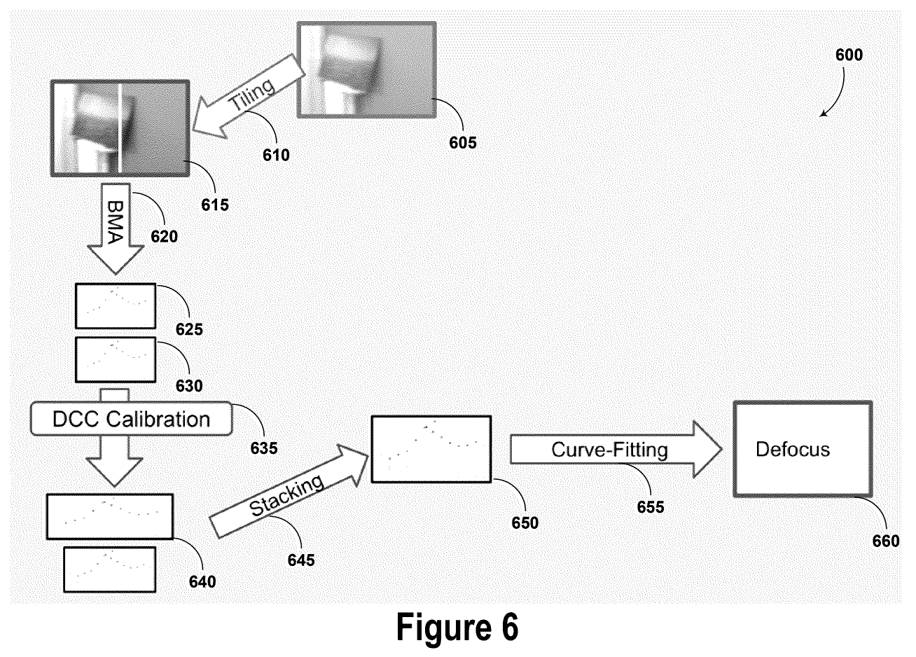

FIG. 6 is an example illustration of a modified PDAF pipeline, in accordance with example embodiments. For example, the DCC calibration may be applied prior to the stacking. In the event there are different DCC calibrations for different tiles (e.g., local sub-regions or local ROIs), the tiles may be stacked temporally even when the lens position changes between frames.

Some embodiments involve receiving, by an image sensor of an image capture device, a pixel array corresponding to phase-detection (PD) pixels for a preview of a scene to be captured by the image capture device. The term “PD pixels” can refer to a pair of images with the same perspective but captured by different parts of a camera lens. In some embodiments, the term “PD pixel” can refer to a stereo pair that includes a left image of a scene and a right image of the scene captured at the PD pixel. In some embodiments, the term “PD pixels” can refer to a PD image tuple (e.g., a quadlet corresponding to Quad pixels). Additional, and/or alternative types of sets of PD pixels may be used.

Some embodiments involve subdividing at least a portion of the pixel array into a plurality of sub-regions. As illustrated in FIG. 6, tiling 610 may be performed on image data 605 in an image sensor to obtain tiled image data 615. BMA 620 may be applied to the tiled image data 615 (e.g., to the PD pixels). Generally, an image frame may include different disparities in different regions. The term “disparity” as used herein generally refers to a focus disparity of an object of interest or a region of interest in an image frame.

Some embodiments involve determining respective local signal strengths associated with each of the plurality of sub-regions. For example, image stats may be determined for each tile of tiled image data 615. In some embodiments, one or more similarity measures, such as first curve 625 and second curve 630, one for each tile of tiled image data 615, may be generated. The term “similarity measure” as used herein generally refers to any measure indicative of a degree of similarity between two images. In some embodiments, the similarity measure may be indicative of a shift between the image frames based on PD pixels (e.g., a shift between a left and a right image in a stereo pair). In some embodiments, respective local DCC calibrations 635 may be applied (e.g., based on respective local signal strengths associated with each of the plurality of sub-regions) to obtain possibly non-aligned similarity curves 640.

Some embodiments involve stacking the respective local signal strengths that have respective applied DCC calibrations. For example, the respective local signal strengths or image stats may be combined by stacking. For example, stacking 645 may be performed to obtain a single similarity curve 650. In some embodiments, curve fitting 655 may be applied to predict the defocus value 660.

One challenge in the approach outlined in FIG. 6 is that after applying DCC calibration 635, the x-coordinates in the similarity curves (e.g., first curve 625 and second curve 630) may not be aligned.

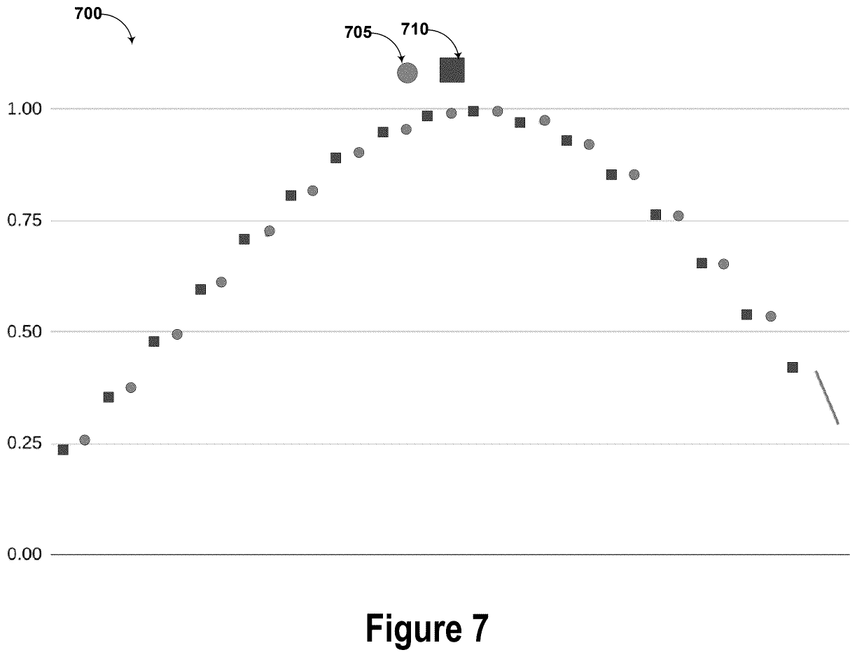

FIG. 7 is an example graphical illustration 700 of two non-aligned local similarity curves, in accordance with example embodiments. For example, a first set of similarity values are depicted using circular markers 705 and a second set of similarity values are depicted using square markers 710. As illustrated, the corresponding x-values for the two sets of similarity values may be different. Also, for example, the corresponding x-values for the two sets of similarity values may not be aligned, thereby making a translation for comparison purposes difficult. For example, although each individual curve may be somewhat evenly spaced, the spacing between curves may differ and their values may not align.

In some embodiments, the similarity curves may be added by interpolating the respective denominators and numerators so that they become real-valued functions (e.g., by applying a suitable subpixel interpolation). However, curve-fitting may become somewhat more challenging, since x-coordinates (e.g., for which the similarity curves have values) may not be aligned. Accordingly, one approach may be to compute a least fitting polynomial in a neighborhood of the x-coordinates.

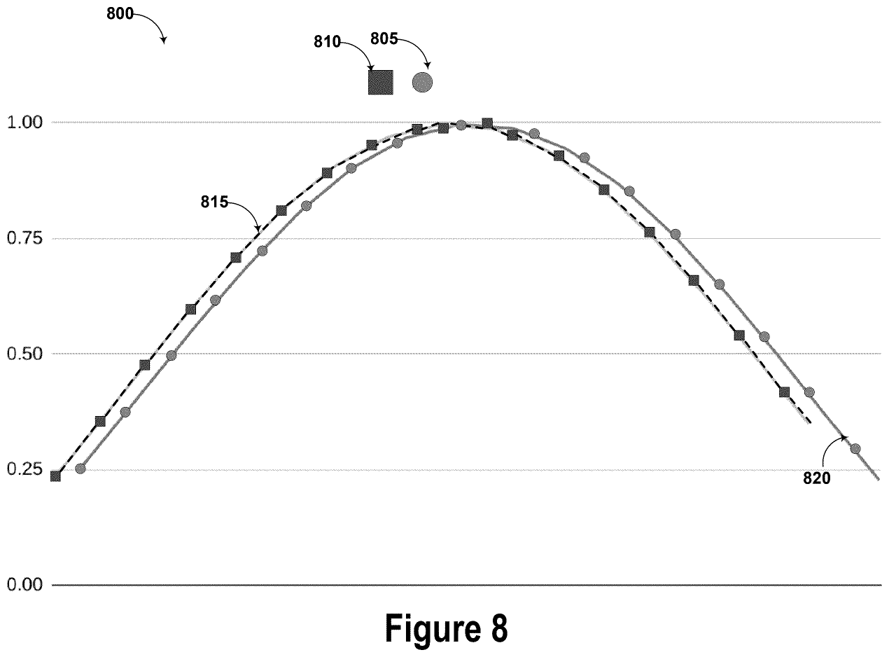

FIG. 8 is an example graphical illustration 800 of interpolating two local similarity curves, in accordance with example embodiments. For example, a least fitting polynomial in a neighborhood of the x-coordinates may be applied to each set of similarity values (e.g., depicted by the circular markers 805 and square markers 810). For example, a first interpolated curve 815 for the similarity values depicted by the square markers 810 may be determined. Also, for example, a second interpolated curve 820 for the similarity values depicted by the circular markers 805 may be determined. The first interpolated curve 815 and the second interpolated curve 820 may then be added up to determine a stacked curve.

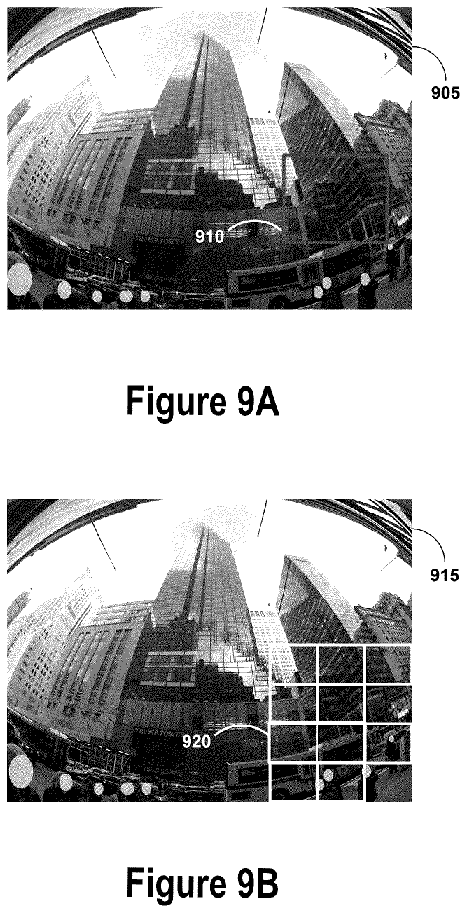

FIG. 9A is an example illustration of focus determination based on ROI location, in accordance with example embodiments. Image 905 includes an ROI 910. The disparity and lens correction depends on characteristics of image 905, and the locations of ROIs such as ROI 910. An example calibration formula may be formulated as:

$$Defocus \sim Disparity * DCC\_slope + DCC\_offset \qquad ( Eqn . 1 )$$

FIG. 9B is an example illustration of determining disparity based on ROI location, in accordance with example embodiments. Image 915 includes an ROI which may be sub-divided into sub-regions of a grid 920. The defocus value may be computed using this grid 920 and Eqn. 1. The DCC coefficients may be determined for each sub-region within the grid 920, and corresponding disparities may be determined.

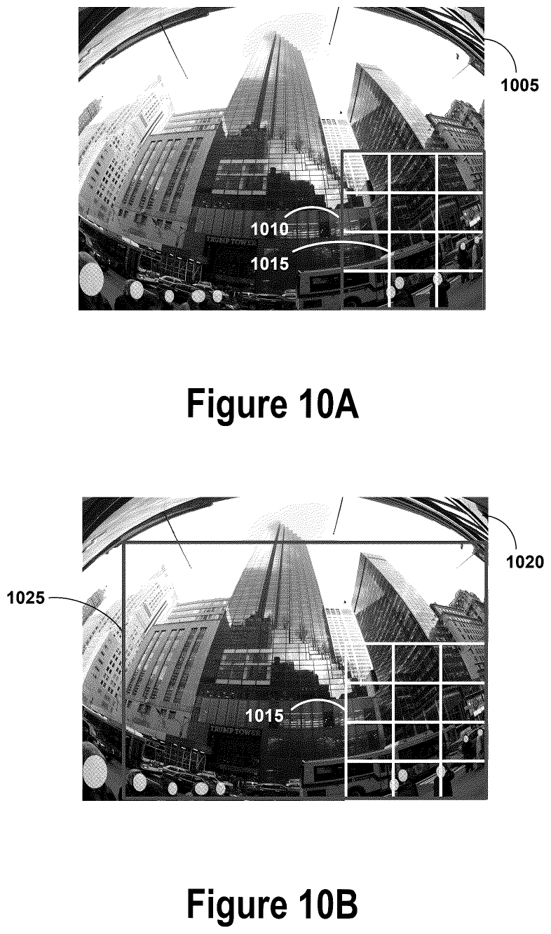

Existing approaches to DCC calibration use a grid of values to generate coefficients. Such approaches may work well for small ROIs because the values within the grid are similar. However, for larger ROIs, the grid values can become more diverse, making it difficult to accurately represent the individual characteristics within the larger ROI. This is somewhat similar to a distorted image, where a small view may resemble reality much more accurately than the bigger picture. The resulting DCC calibration on a larger ROI will likely not reflect local reality, which becomes relevant when image characteristics are not similar (e.g., objects of interest, brightness level, etc.). FIGS. 10A and 10B describe a motivation for using small ROIs.

FIG. 10A is an example illustration of an existing approach to determining disparity, in accordance with example embodiments. Image 1005 illustrates an ROI 1010 indicated by a square with red sides, subdivided into smaller tiles as indicated by grid 1015 that includes smaller squares with white sides. By subdividing the ROI 1010 into smaller tiles as in grid 1015, each tile may be treated as a small ROI. This allows for more accurate DCC calibration within each tile. The resulting similarity curves from each tile may then be stacked to create a comprehensive representation of the entire ROI 1010.

Although the term grid is used herein, there may be two types of grids. A first type of grid is a DCC Calibration Grid that may be used in the DCC calibration process itself. A second type of grid may be a Tiling Grid formed by the tiles that subdivide the ROI. Note that the ROI may naturally align with such a tiling grid. Each tile is a tiling grid may be treated as a small ROI.

FIG. 10B is another example illustration of an existing approach to determining disparity, in accordance with example embodiments. Image 1020 illustrates a larger ROI 1025. Calibrations based on the larger ROI 1025 may not accurately reflect local reality for the portion of the image inside grid 1015, which becomes relevant if image characteristics are not similar (e.g., objects of interest, brightness level, etc.).

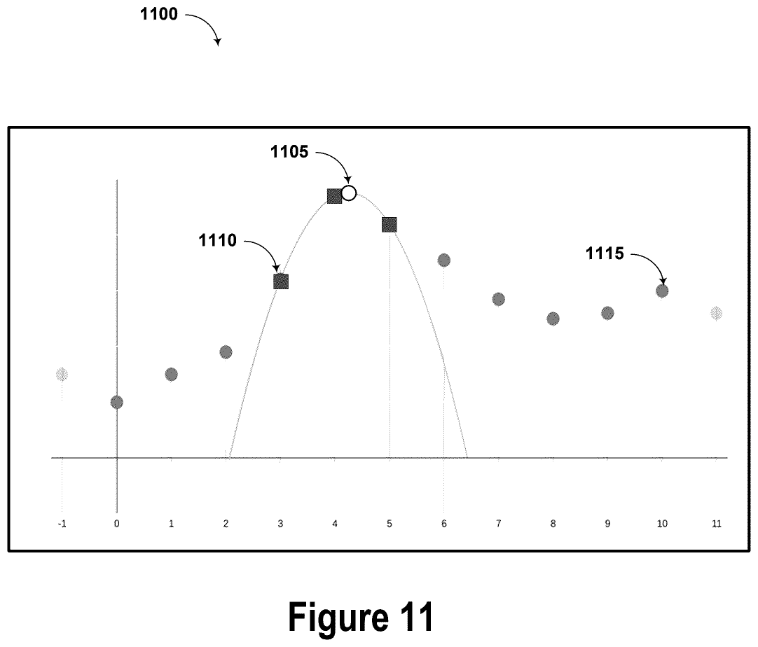

FIG. 11 is an example graphical illustration 1100 of sub-pixel interpolation, in accordance with example embodiments. For example, two sets of values for local similarity curves corresponding to local ROIs are shown. A first set of values includes values denoted by filled in black squares (e.g., red square 1110), and a second set of values includes values denoted by filled in grey circles (e.g., blue circle 1115). A true maximum for the two sets of values may be determined, as indicated by white circle 1105. In some embodiments, the true maximum may be chosen as a non-integer value. Generally, the true maximum indicates an amount of lens adjustment to be applied for a target defocus value.

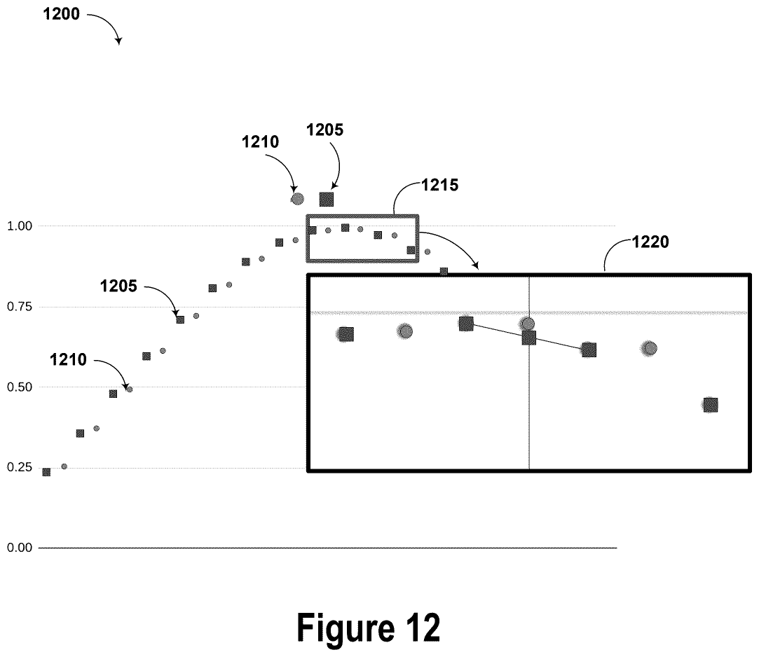

FIG. 12 is an example graphical illustration 1200 of interpolation prior to sub-pixel interpolation, in accordance with example embodiments. For example, two sets of values for local similarity curves corresponding to local ROIs are shown. A first set of values includes values denoted by filled in squares (e.g., square 1905), and a second set of values includes values denoted by filled in circles (e.g., circle 1210). Box 1920 is an enlarged view of box 1215 and illustrates interpolation. For example, the filled in squares (e.g., square 1905) may be interpolated to determine a similarity curve. Generally, the filled in squares may be determined from six constituent terms for a zero-normalized cross-correlation (ZNCC) and each of these six values may be interpolated. The interpolation may be applied prior to the sub-pixel interpolation, as described with reference to FIG. 11.

Some embodiments involve stacking respective local signal strengths (e.g., similarity measures) that have respective DCC calibrations applied. The term “stacking” as used herein generally refers to combining image stats or similarity measures that are indicative of respective frame disparities in PD pixels. In terms of similarity measures, there may be several ways to stack the similarity measures. Generally, this may involve summing a few discrete components of the similarity measures. Such a sum is generally not computationally resource intensive.

Some embodiments involve determining an aggregated similarity measure by aggregating respective similarity measures corresponding to the plurality of successive image frames. The term “aggregated similarity measure” as used herein generally refers to combining similarity measures that are indicative of respective frame disparities in image frames with PD pixels. There may be several ways to combine the similarity measures. Generally, this may involve summing a few discrete components of the similarity measures. Such a sum is not computationally resource intensive.

For purposes of stacking, a normalized cross-correlation (NCC) may be determined as:

$$NCC = \frac{〈 L , R 〉}{\sqrt{〈 L , L 〉 〈 R , R 〉}} \qquad ( Eqn . 2 )$$

where L and R denote the left and right images respectively and <, > denotes the Frobenius product. Scalar products other than the Frobenius product may also be used. Such a formulation is valid in the presence of a (canonical) inner product between the left and right images. For example, subregions of the sets of PD image frames (i.e. (shifted) regions of interest (ROIs)) may be used. Also, for example, temporal data may be applied, that transforms L and R into three-dimensional tensors. The three constituents of the NCC in Eqn. 2 may be referred to as a numerator <L, R>, a left denominator <L, L> and a right denominator <R, R>. Generally, these terms commute with (direct) sums. For example, the numerator of several frames is a sum of numerators of each individual frame. Similar considerations apply to the denominators. This may be generally referred to as a stacking property.

In some embodiments, the stacking of the respective local signal strengths and/or determining of the aggregated similarity measure includes aggregating constituent terms for a zero-normalized cross-correlation (ZNCC). One formulation of the ZNCC may be a NCC of normalized images, where an average pixel value may be subtracted from each image. This extra step does not impact an ability to stack images, as long as each frame is assumed to be associated with a respective zero-normalization. In this case, the stacked ZNCC is substantially similar to the ZNCC of the individual images glued together.

Another formulation of the ZNCC may be based on a linearity property of the scalar product and rearranging terms. This is an efficient way to compute the ZNCC and also has the stacking property. Constituents of the formulation may be aggregated to obtain the ZNCC of several frames. For example, the ZNCC may be computed based on six (6) constituent terms. In this case, the stacked ZNCC is the same as the ZNCC of the individual images glued together.

Additional and/or alternative similarity measures may be used, such as, for example, a sum of absolute differences (SAD), sum of squared differences (SSD), and cross-correlation. Such measures have a formulation that has the stacking property, and may be used in a PDAF-pipeline.

For example, a sum of squared differences may be determined as:

$$SSD ( {Img}_{1} , {Img}_{2} , {u}_{1} , {v}_{1} , {u}_{2} , {v}_{2} n ) = {\sum }_{i = - n j}^{n} {\sum }_{= - n}^{n} {( {Img}_{1} ( {u}_{1} + i , {v}_{1} + j ) - {Img}_{2} ( {u}_{2} + i , {v}_{2} + j ) )}^{2} \qquad ( Eqn . 3 )$$

For two identical images, the sum of squared differences is zero. A value close to zero indicates that the images are highly similar.

In some embodiments, the stacking of the respective local signal strengths and/or determining of the aggregated similarity measure includes aggregating constituent terms for a sum of absolute differences (SAD) of the image frames in a set of PD image frames. A sum of absolute differences (SAD) measures similarity between image blocks. An absolute difference is determined between each pixel in a block in the first image and in a corresponding block in the second image. The differences may be summed up to generate a block similarity. The SAD may be determined as:

$$SAD ( {Img}_{1} , {Img}_{2} , {u}_{1} , {v}_{1} , {u}_{2} , {v}_{2} n ) = {\sum }_{i = - n j}^{n} {\sum }_{= - n}^{n} \vert {Img}_{1} ( {u}_{1} + i , {v}_{1} + j ) - {Img}_{2} ( {u}_{2} + i , {v}_{2} + j ) \vert \qquad ( Eqn . 4 )$$

In some embodiments, the stacking of the respective local signal strengths and/or determining of the aggregated similarity measure includes aggregating constituent terms for a median of absolute differences (MAD) of the image frames in a set of PD image frames. A median of absolute differences (MAD) also measures similarity between image blocks. An absolute difference is determined between each pixel in a block in the first image and in a corresponding block in the second image. A median of the differences may be determined to generate a similarity measure. The MAD may be determined as:

$$MAD ( {Img}_{1} , {Img}_{2} , {u}_{1} , {v}_{1} , {u}_{2} , {v}_{2} n ) = {\sum }_{i = - n j}^{n} {\sum }_{= - n}^{n} median ( {Img}_{1} ( {u}_{1} + i , {v}_{1} + j ) - {Img}_{2} ( {u}_{2} + i , {v}_{2} + j ) ) \qquad ( Eqn . 5 )$$

In some embodiments, the stacking of the respective local signal strengths and/or determining of the aggregated similarity measure may be performed temporally. For example, the stacked similarity measure may be based on a plurality of sets of PD image frames captured over time. In some embodiments, the stacking of the respective local signal strengths may be performed spatio-temporally. For example, the stacked similarity measure may be based on a plurality of sets of PD image frames captured over time, and additionally based on depth information in the plurality of sets of PD images. Also, for example, the ROI may be made temporally larger (e.g., to improve the signal).

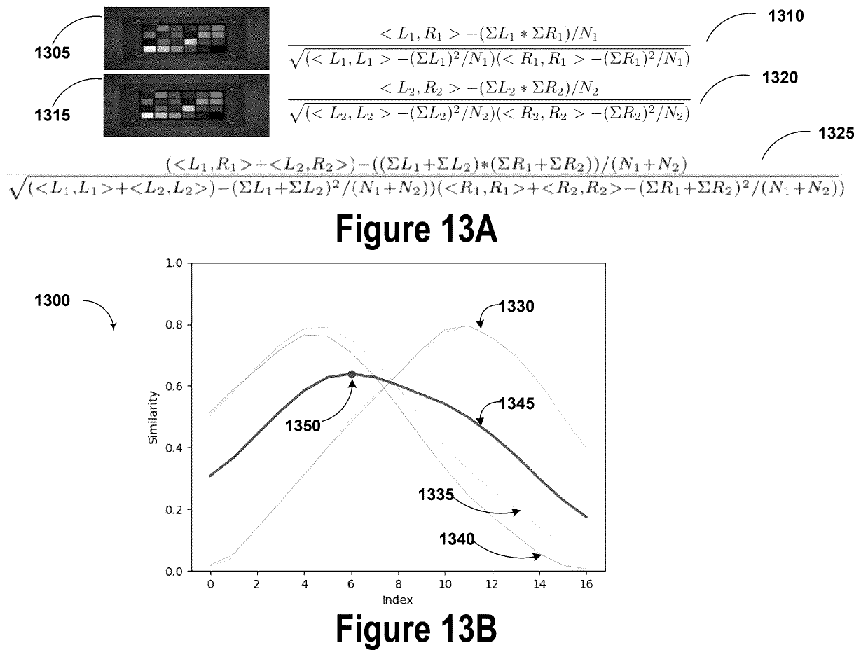

FIG. 13A is an example illustration of determining zero-normalized cross-correlation (ZNCC) values, in accordance with example embodiments. For a given pair of image frames, L and R, image 1305 corresponds to a comparison of a first image subblock L₁ of L and a first image subblock R₁ of R. The cross-correlation values may be determined by first relation 1310, where N₁ denotes the number of pixels. Image 1315 corresponds to a comparison of a second image subblock L₂ of L and a second image subblock R₂ of R. The cross-correlation values may be determined by second relation 1320, where N₂ denotes the number of pixels. The values obtained from first relation 1310 and second relation 1320 may be added as illustrated by third relation 1325. These sums may be computed for pairwise image blocks to determine a ZNCC curve. A peak of the ZNCC curve indicates a high degree of similarity.

FIG. 13B is an example graphical illustration 1300 of stacked signal strengths, in accordance with example embodiments. A plurality of local similarity measures (e.g., ZNCC curves) are shown, such as, for example, a first similarity curve 1330, a second similarity curve 1335, and a third similarity curve 1340. These curves may be determined based on interpolation applied prior to sub-pixel interpolation, as described with reference to FIGS. 11 and 12. A stacked similarity curve 1345 is shown with a peak similarity value 1350. The peak similarity value 1350 indicates an amount of lens adjustment to be applied for a predicted defocus value.

Generally, when based on the local similarity curves, stacking results in highlighting features with a relevant ROI (e.g., an ROI with lot of textured content) as opposed to a less significant ROI (e.g., an ROI with a significant amount of blank space). Generally speaking, stacking reduces a shift, and a peak similarity value (e.g., peak similarity value 1350). This can lead to improved confidence in the disparity and the defocus value determinations.

For example, a peak similarity value 1350 and a curvature value (not shown) for stacked similarity curve 1345 may be determined. In some embodiments, these values may be provided to a confidence model to generate a confidence level. Some embodiments involve determining whether the peak similarity value exceeds a peak threshold. Such embodiments also involve, upon a determination that the peak similarity value exceeds the peak threshold, associating the predicted defocus value with a high confidence level. For example, the confidence model may determine whether the peak similarity 1350 exceeds a peak threshold. Upon a determination that the peak similarity 1350 exceeds the peak threshold, the confidence model may associate the predicted defocus value with a confidence level indicative of high confidence. Upon a determination that the peak similarity 1350 does not exceed the peak threshold, the confidence model may associate the predicted defocus value with a confidence level indicative of low confidence.

Some embodiments involve determining whether the curvature is within a curvature threshold. Such embodiments also involve, upon a determination that the curvature is within the curvature threshold, associating the predicted focus disparity with a high confidence level. For example, the confidence model may determine whether the curvature value is within a curvature threshold. Upon a determination that the curvature value is within the curvature threshold, the confidence model may associate the predicted defocus value with a confidence level indicative of high confidence. Upon a determination that the curvature value is not within the curvature threshold, the confidence model may associate the predicted defocus value with a confidence level indicative of low confidence.

Generally speaking, camera calibration may perform a defocus adjustment based on the confidence level. For example, the camera lens may be adjusted from the initial position to a target position in the event that the confidence level is indicative of high confidence. Also, for example, the camera lens may not be adjusted from the initial position to the target position in the event that the confidence level is indicative of low confidence.

Generally, a ZNCC formulation implicitly incorporates weighting based on energy characteristics. For example, a denominator of the ZNCC formulation corresponds to energy. In some embodiments, local similarity curves may be averaged and/or weighted based on one or more image characteristics, such as those, for example, that contribute to signal strength. For example, a higher weight may be associated with an ROI of more complex image characteristics, and a lower weight may be associated with an ROI of less complex image characteristics. In such embodiments, the adjusting of the lens position based on the predicted defocus value may correspond to determining a stacked similarity measure by stacking respective weighted local similarity measures. For example, ROIs that have higher energy may be weighted to contribute more to the stacked similarity measure. In some embodiments, local similarity curves may be stacked and/or weighted by other factors such as confidence levels, motion statistics, and so forth.

Performing PDAF may be challenging for camera systems, for example, in some extreme lowlight conditions. A fewer number of captured photons may limit available information, and accurate focus acquisition may be impeded. One approach to solving this problem is to stack the intermediate processing outputs of the PDAF pipeline, specifically similarity curves. This combines advantages of temporally stacking PD raw images (or increasing exposure time) before the pipeline, and advantages of temporally smoothing PDAF-results post pipeline.

Additional and/or alternative factors may determine when to trigger a determination of stacked signal strengths. For example, determination of stacked signal strengths may be triggered when the ambient light for the scene is below a threshold brightness. Also, for example, determination of stacked signal strengths may be triggered in the event of significant lens movement between image frames. As another example, determination of stacked signal strengths may be triggered in the event a large ROI is detected.

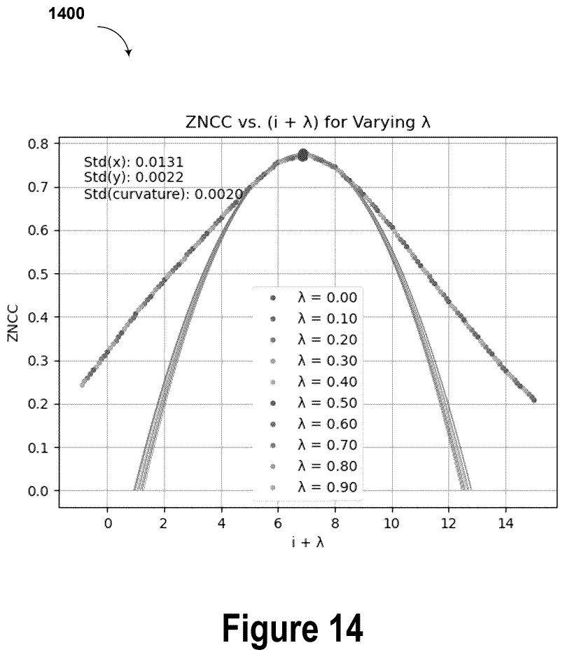

FIG. 14 is an example graphical illustration 1400 of possible losses from interpolation, in accordance with example embodiments. For example, values for ZNCC are represented along the vertical or y-axis, and i+λ values are represented along the horizontal or x-axis. FIG. 14 illustrates the different interpolations obtained by shifting by lambda (and can be used as an interpolation for that). Ideally, all interpolation parabolas may be expected to be the same (i.e., no loss). In practice, the interpolation parabolas may differ. The standard deviations of a key characteristics peak similarity (x), disparity/defocus (y), and curvature may be determined for each of the interpolation parabolas. These standard deviations are small, indicating that the possible losses due to interpolation are negligible for practical purposes.

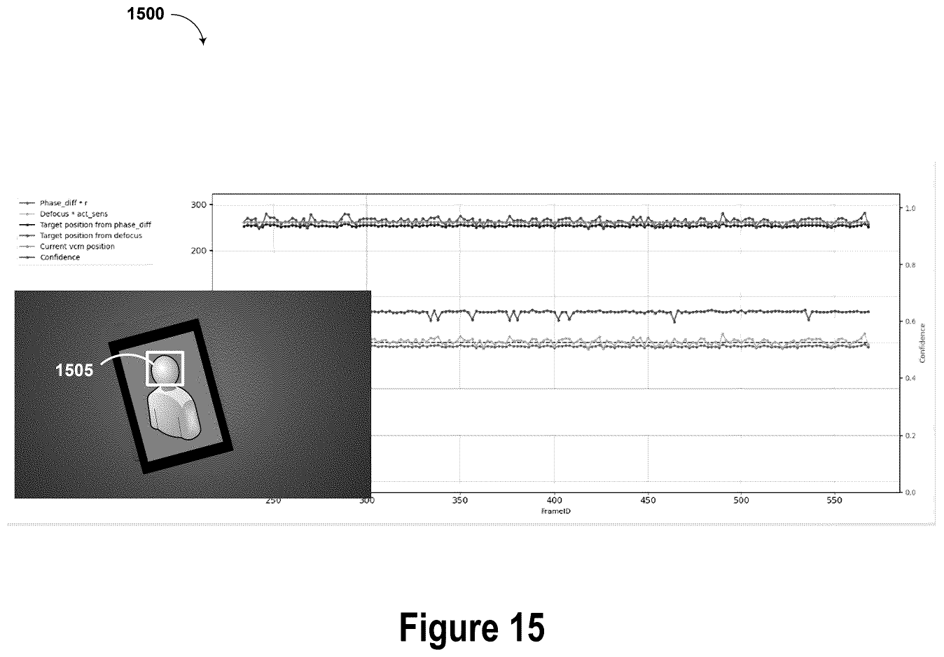

FIG. 15 is an example graphical illustration 1500 of defocus conversion coefficient (DCC) stacking with ground truth data, in accordance with example embodiments. The ground truth is measured with reference to a face ROI 1505. The horizontal or x-axis represents a frame identifier and the vertical axis represents a confidence level for disparity determination.

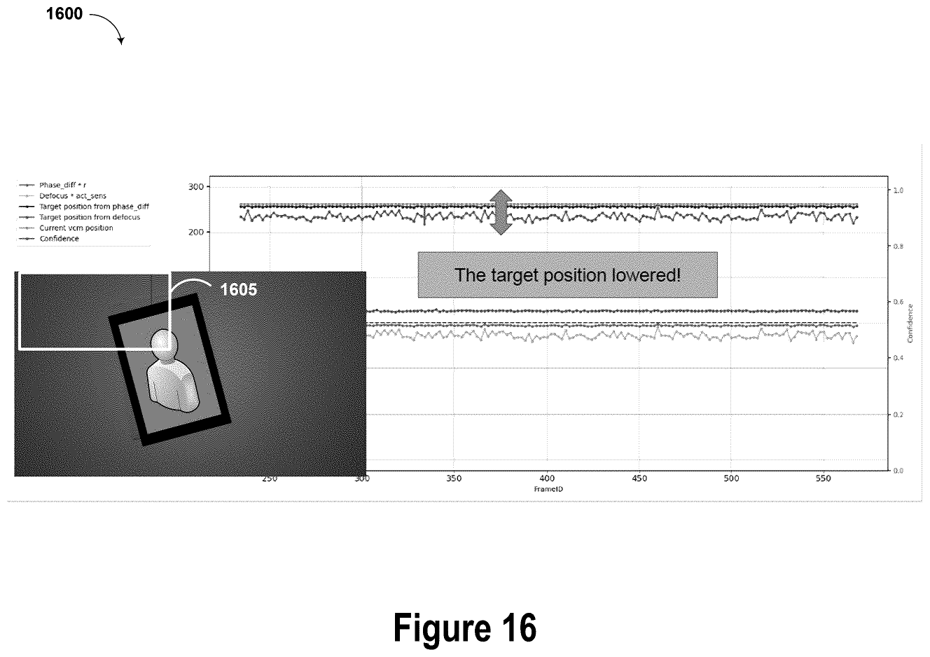

FIG. 16 is an example graphical illustration 1600 of DCC stacking with a decreased target distance from a defocus value, in accordance with example embodiments. The defocus value is determined with reference to an ROI 1605. As illustrated, ROI 1605 includes a substantial portion that does not include significant texture (e.g., is substantially blank). The horizontal or x-axis represents a frame identifier and the vertical axis represents a confidence level for disparity determination. As expected, the defocus value determination does not capture the relevant portion of ROI 1605, and lowers the confidence level or target position.

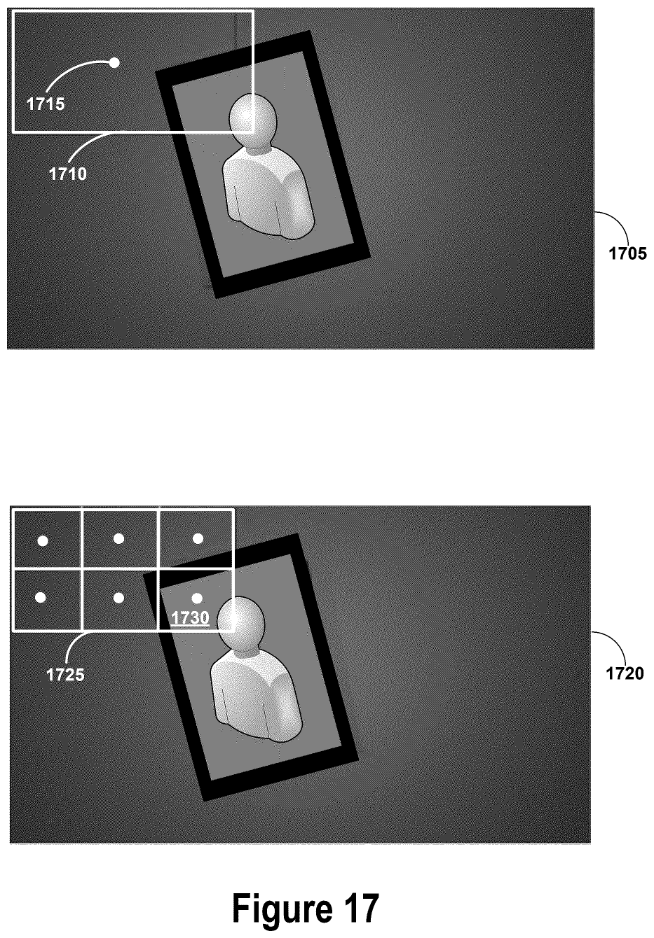

FIG. 17 is an example illustration of local DCC calibration, in accordance with example embodiments. Image 1705 illustrates a DCC calibration based on ROI 1710 (as illustrated with reference to FIG. 16). As indicated, the DCC calibration may be based on a center 1715, and such a DCC calibration may be sub-optimal as it fails to assign proper weight to a relevant sub-region of ROI 1710.

Image 1720 illustrates a DCC calibration based on stacking local DCC calibrations. Region 1725 may be subdivided into sub-regions, such as the six sub-regions shown, including sub-region 1730. Each of the six sub-regions may be associated with a respective local DCC calibration. The five sub-regions other than sub-region 1730 do not include any significant image features (e.g., these five sub-regions are blank). Accordingly, the local similarity curves corresponding to these five sub-regions are likely to be substantially flat. However, sub-region 1730 includes a portion of the portrait, and the respective local similarity curve corresponding to sub-region 1730 is likely to represent the features of sub-region 1730. Accordingly, when the local similarity curves are stacked, the stacked similarity curve is likely to be based substantially on the local similarity curve corresponding to sub-region 1730. Accordingly, the ROI 1710 is now more accurately calibrated when subdivided as in region 1725.

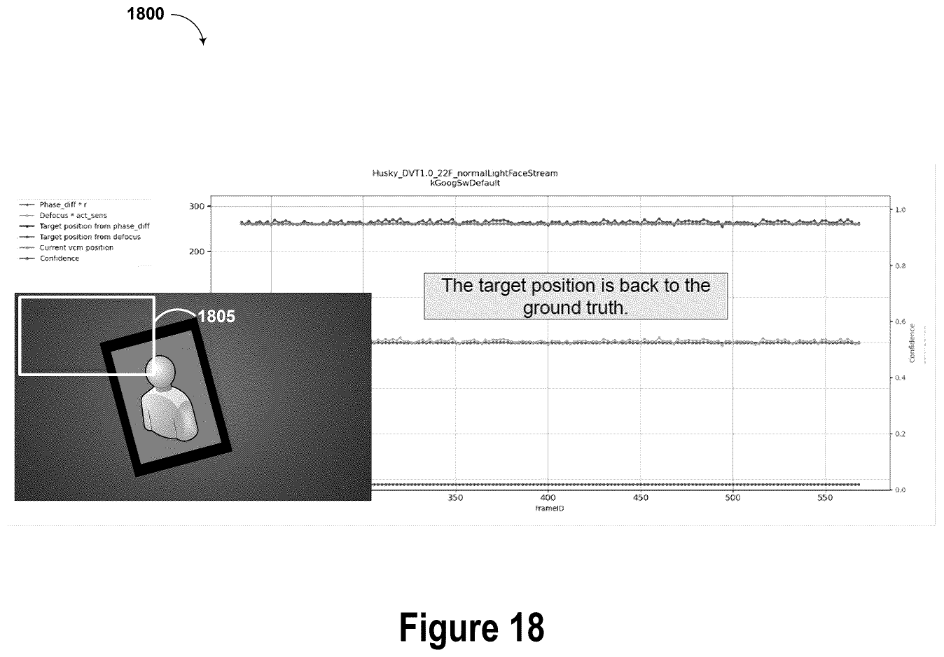

FIG. 18 is an example graphical illustration 1800 of DCC stacking that aligns with the ground truth data, in accordance with example embodiments. The defocus value is determined with reference to a subdivided region 1725 of FIG. 17. As illustrated, the substantially blank portions of image 1725 no longer make a significant contribution to the DCC calibration, as the DCC calibration is weighted to sub-region 1730 of image 1725. The horizontal or x-axis represents a frame identifier and the vertical axis represents a confidence level for disparity determination. As expected, the defocus value determination captures the relevant portion corresponding to sub-region 1730 of image 1725. Accordingly, the confidence level or target position is now close to the ground truth values of FIG. 15.

### Computing Device Architecture

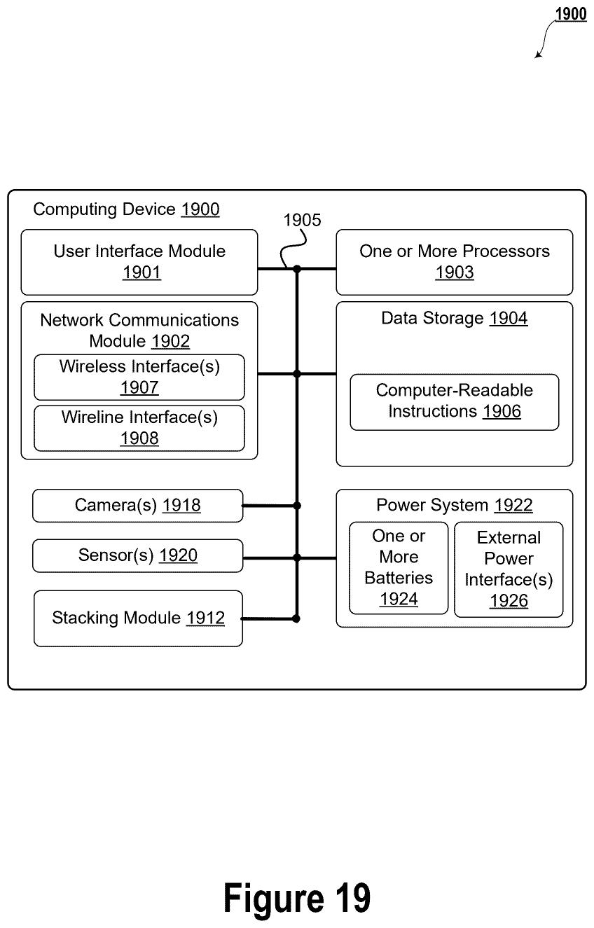

FIG. 19 is a block diagram of an example computing device 1900, in accordance with example embodiments. In particular, computing device 1900 shown in FIG. 19 can be configured to perform at least one function described herein, including method 2000.

Computing device 1900 may include a user interface module 1901, a network communications module 1902, one or more processors 1903, data storage 1904, one or more cameras 1918, one or more sensors 1920, and power system 1922, all of which may be linked together via a system bus, network, or other connection mechanism 1905.

User interface module 1901 can be operable to send data to and/or receive data from external user input/output devices. For example, user interface module 1901 can be configured to send and/or receive data to and/or from user input devices such as a touch screen, a computer mouse, a keyboard, a keypad, a touch pad, a trackball, a joystick, a voice recognition module, and/or other similar devices. User interface module 1901 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 1901 can also be configured to generate audible outputs, with devices such as a speaker, speaker jack, audio output port, audio output device, earphones, and/or other similar devices. User interface module 1901 can further be configured with one or more haptic devices that can generate haptic outputs, such as vibrations and/or other outputs detectable by touch and/or physical contact with computing device 1900. In some examples, user interface module 1901 can be used to provide a graphical user interface (GUI) for utilizing computing device 1900.

Network communications module 1902 can include one or more devices that provide one or more wireless interfaces 1907 and/or one or more wireline interfaces 1908 that are configurable to communicate via a network. Wireless interface(s) 1907 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 1908 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 1902 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 1903 can include one or more general purpose processors (e.g., central processing unit (CPU), etc.), and/or one or more special purpose processors (e.g., digital signal processors, tensor processing units (TPUs), graphics processing units (GPUs), application specific integrated circuits, etc.). One or more processors 1903 can be configured to execute computer-readable instructions 1906 that are contained in data storage 1904 and/or other instructions as described herein.

Data storage 1904 can include one or more non-transitory computer-readable storage media that can be read and/or accessed by at least one of one or more processors 1903. The one or more computer-readable storage media can include volatile and/or non-volatile storage components, such as optical, magnetic, organic or other memory or disc storage, which can be integrated in whole or in part with at least one of one or more processors 1903. In some examples, data storage 1904 can be implemented using a single physical device (e.g., one optical, magnetic, organic or other memory or disc storage unit), while in other examples, data storage 1904 can be implemented using two or more physical devices.

Data storage 1904 can include computer-readable instructions 1906 and perhaps additional data. In some examples, data storage 1904 can include storage required to perform at least part of the herein-described methods, scenarios, and techniques and/or at least part of the functionality of the herein-described devices and networks. In particular, computer-readable instructions 1906 can include instructions that, when executed by processor(s) 1903, enable computing device 1900 to provide for some or all of the functionality described herein.

In some embodiments, computer-readable instructions 1906 can include instructions that, when executed by processor(s) 1903, enable computing device 1900 to carry out operations. The operations may include receiving, by an image sensor of a camera of the computing device, a pixel array corresponding to phase-detection pixels for a preview of a scene to be captured by the camera. The operations may also include subdividing at least a portion of the pixel array into a plurality of sub-regions. The operations may additionally include applying, based on a respective local signal strength associated with each of the plurality of sub-regions, a respective local defocus conversion coefficient (DCC) calibration. The operations may further include predicting, by stacking the respective local signal strengths that have respective applied DCC calibrations, a defocus value for phase-detection autofocus (PDAF). The operations may also include providing, based on the predicted defocus value, an adjustment to a lens position for the camera.

In some embodiments, the at least a portion of the pixel array includes at least one region of interest (ROI), and wherein each of the plurality of sub-regions corresponds to a local ROI located within the at least one ROI.

In some embodiments, each of the respective local signal strengths may be associated with a corresponding local lens position, and wherein the adjustment to the lens position is based on the local lens positions.

In some embodiments, the operations for the applying of the respective local DCC calibrations may be performed prior to applying a subpixel interpolation technique.

In some embodiments, the operations for the applying of the respective local DCC calibrations involve operations for determining respective local similarity measures for each of the plurality of sub-regions, and wherein the operations for stacking of the respective local signal strengths involve operations for aggregating the respective local similarity measures.

In some embodiments, the operations for aggregating of the respective local similarity measures involve operations for applying an interpolation technique to combine the respective local similarity measures.

In some embodiments, the operations involve operations for determining, based on the respective local similarity measures, a peak similarity value. Such embodiments involve operations for determining whether the peak similarity value exceeds a peak threshold. Such embodiments also involve operations for, upon a determination that the peak similarity value exceeds the peak threshold, associating the predicted defocus value with a high confidence level.

In some embodiments, the operations involve operations for determining a curvature for the aggregated respective local similarity measures. Such embodiments involve operations for determining whether the curvature is within a curvature threshold. Such embodiments also involve operations for, upon a determination that the curvature is within the curvature threshold, associating the predicted defocus value with a high confidence level.

In some embodiments, the operations involve operations for receiving a plurality of image frames, each image frame comprising a respective pixel array. Such embodiments involve operations for determining whether a lens movement between a pair of successive frames exceeds a movement threshold. The applying of the respective local DCC calibrations may be performed based on a determination that the lens movement between the pair of successive frames exceeds the movement threshold.

In some embodiments, the operations involve operations for determining that the lens movement between the pair of successive frames does not exceed the movement threshold. Such embodiments involve operations for determining a respective global similarity measure for each of the pair of successive frames. Such embodiments also involve operations for determining an aggregated similarity measure by aggregating the respective global similarity measures. The predicting of the defocus value for PDAF may be based on the aggregated similarity measure.

In some embodiments, the operations for the determining of the aggregated similarity measure may be performed spatio-temporally.

In some embodiments, an ambient light for the scene may be below a threshold brightness.

In some examples, computing device 1900 can include stacking module 1912. Stacking module 1912 can be configured to determine a stacked signal strength (e.g., stacked similarity measures) and predict a defocus value for phase-detection autofocus (PDAF). Also, for example, stacking module 1912 can be configured to determine when to trigger the applying of the respective local DCC calibrations.

In some examples, computing device 1900 can include one or more cameras 1918. Camera(s) 1918 can include one or more image capture devices, such as still and/or video cameras, equipped to capture light and record the captured light in one or more images; that is, camera(s) 1918 can generate image(s) of captured light. The one or more images can be one or more still images and/or one or more images utilized in video imagery. Camera(s) 1918 can capture light and/or electromagnetic radiation emitted as visible light, infrared radiation, ultraviolet light, and/or as one or more other frequencies of light. Camera(s) 1918 can include a wide camera, a tele camera, an ultrawide camera, and so forth. Also, for example, camera(s) 1918 can be front-facing or rear-facing cameras with reference to computing device 1900. Camera(s) 1918 can include camera components such as, but are not limited to, an aperture, shutter, recording surface (e.g., photographic film and/or an image sensor), lens, and/or shutter button. The camera components may be controlled at least in part by software executed by one or more processors 1903.

In some examples, computing device 1900 can include one or more sensors 1920. Sensors 1920 can be configured to measure conditions within computing device 1900 and/or conditions in an environment of computing device 1900 and provide data about these conditions. For example, sensors 1920 can include one or more of: (i) sensors for obtaining data about computing device 1900, such as, but not limited to, a thermometer for measuring a temperature of computing device 1900, a battery sensor for measuring power of one or more batteries of power system 1922, and/or other sensors measuring conditions of computing device 1900; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 1900, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 1900, such as, but not limited to, an infrared sensor, an optical sensor, a light sensor (e.g., an ambient light sensor), a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 1900, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 1920 are possible as well.

Power system 1922 can include one or more batteries 1924 and/or one or more external power interfaces 1926 for providing electrical power to computing device 1900. Each battery of the one or more batteries 1924 can, when electrically coupled to the computing device 1900, act as a source of stored electrical power for computing device 1900. One or more batteries 1924 of power system 1922 can be configured to be portable. Some or all of one or more batteries 1924 can be readily removable from computing device 1900. In other examples, some or all of one or more batteries 1924 can be internal to computing device 1900, and so may not be readily removable from computing device 1900. Some or all of one or more batteries 1924 can be rechargeable. For example, a rechargeable battery can be recharged via a wired connection between the battery and another power supply, such as by one or more power supplies that are external to computing device 1900 and connected to computing device 1900 via the one or more external power interfaces. In other examples, some or all of one or more batteries 1924 can be non-rechargeable batteries.

One or more external power interfaces 1926 of power system 1922 can include one or more wired-power interfaces, such as a USB cable and/or a power cord, that enable wired electrical power connections to one or more power supplies that are external to computing device 1900. One or more external power interfaces 1926 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1926, computing device 1900 can draw electrical power from the external power source the established electrical power connection. In some examples, power system 1922 can include related sensors, such as battery sensors associated with the one or more batteries or other types of electrical power sensors.

One or more external power interfaces 1926 of power system 1922 can include one or more wired-power interfaces, such as a USB cable and/or a power cord, that enable wired electrical power connections to one or more power supplies that are external to computing device 1900. One or more external power interfaces 1926 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1926, computing device 1900 can draw electrical power from the external power source the established electrical power connection. In some examples, power system 1922 can include related sensors, such as battery sensors associated with the one or more batteries or other types of electrical power sensors.

### Example Methods of Operation

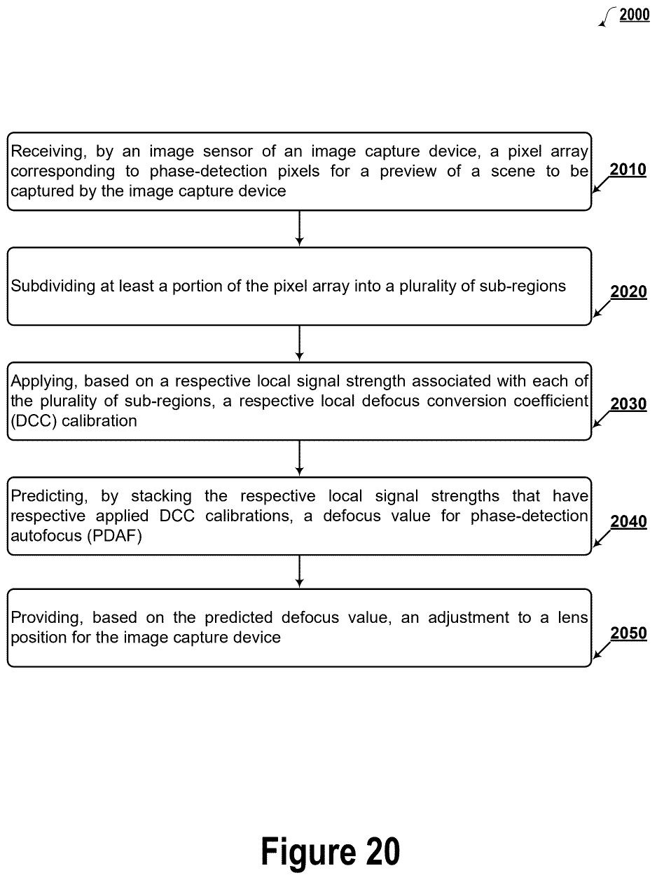

FIG. 20 is a flowchart of a method, in accordance with example embodiments. Method 2000 may include various blocks or steps. The blocks or steps may be carried out individually or in combination. The blocks or steps may be carried out in any order and/or in series or in parallel. Further, blocks or steps may be omitted or added to method 2000.

The blocks of method 2000 may be carried out by various elements of computing device 1900 as illustrated and described in reference to FIG. 19.

Block 2010 involves receiving, by an image sensor of an image capture device, a pixel array corresponding to phase-detection pixels for a preview of a scene to be captured by the image capture device.

Block 2020 involves subdividing at least a portion of the pixel array into a plurality of sub-regions.

Block 2030 involves applying, based on a respective local signal strength associated with each of the plurality of sub-regions, a respective local defocus conversion coefficient (DCC) calibration.

Block 2040 involves predicting, by stacking the respective local signal strengths that have respective applied DCC calibrations, a defocus value for phase-detection autofocus (PDAF).

Block 2040 involves providing, based on the predicted defocus value, an adjustment to a lens position for the image capture device.

In some embodiments, the at least a portion of the pixel array includes at least one region of interest (ROI), and wherein each of the plurality of sub-regions corresponds to a local ROI located within the at least one ROI.

In some embodiments, each of the respective local signal strengths is associated with a corresponding local lens position, and wherein the adjustment to the lens position is based on the local lens positions.

In some embodiments, the applying of the respective local DCC calibrations is performed prior to applying a subpixel interpolation technique.

In some embodiments, the applying of the respective local DCC calibrations involves determining respective local similarity measures for each of the plurality of sub-regions, and wherein the stacking of the respective local signal strengths involves aggregating the respective local similarity measures.

In some embodiments, the aggregating of the respective local similarity measures involves applying an interpolation technique to combine the respective local similarity measures.

Some embodiments involve determining, based on the respective local similarity measures, a peak similarity value. Such embodiments involve determining whether the peak similarity value exceeds a peak threshold. Such embodiments also involve, upon a determination that the peak similarity value exceeds the peak threshold, associating the predicted defocus value with a high confidence level.

Some embodiments involve determining a curvature for the aggregated respective local similarity measures. Such embodiments involve determining whether the curvature is within a curvature threshold. Such embodiments also involve, upon a determination that the curvature is within the curvature threshold, associating the predicted defocus value with a high confidence level.

Some embodiments involve receiving a plurality of image frames, each image frame comprising a respective pixel array. Such embodiments involve determining whether a lens movement between a pair of successive frames exceeds a movement threshold. The applying of the respective local DCC calibrations may be performed based on a determination that the lens movement between the pair of successive frames exceeds the movement threshold.

Some embodiments involve determining that the lens movement between the pair of successive frames does not exceed the movement threshold. Such embodiments involve determining a respective global similarity measure for each of the pair of successive frames. Such embodiments also involve determining an aggregated similarity measure by aggregating the respective global similarity measures. The predicting of the defocus value for PDAF may be based on the aggregated similarity measure.

In some embodiments, the determining of the aggregated similarity measure may be performed spatio-temporally.

In some embodiments, an ambient light for the scene may be below a threshold brightness.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods. Thus, the computer readable media may include secondary or persistent long-term storage, like read only memory (ROM), optical or magnetic disks, compact disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A computer-implemented method, comprising:
receiving, by an image sensor of an image capture device, a pixel array corresponding to phase-detection pixels for a preview of a scene to be captured by the image capture device;
subdividing at least a portion of the pixel array into a plurality of sub-regions;
applying, based on a respective local signal strength associated with each of the plurality of sub-regions, a respective local defocus conversion coefficient (DCC) calibration;
predicting, by stacking the respective local signal strengths that have respective applied DCC calibrations, a defocus value for phase-detection autofocus (PDAF); and
providing, based on the predicted defocus value, an adjustment to a lens position for the image capture device.

2. The computer-implemented method of claim 1, wherein the at least a portion of the pixel array comprises at least one region of interest (ROI), and wherein each of the plurality of sub-regions corresponds to a local ROI located within the at least one ROI.

3. The computer-implemented method of claim 1, wherein each of the respective local signal strengths is associated with a corresponding local lens position, and wherein the adjustment to the lens position is based on the local lens positions.

4. The computer-implemented method of claim 1, wherein the applying of the respective local DCC calibrations is performed prior to applying a subpixel interpolation technique.

5. The computer-implemented method of claim 1, wherein the applying of the respective local DCC calibrations comprises determining respective local similarity measures for each of the plurality of sub-regions, and wherein the stacking of the respective local signal strengths comprises aggregating the respective local similarity measures.

6. The computer-implemented method of claim 5, wherein the aggregating of the respective local similarity measures comprises applying an interpolation technique to combine the respective local similarity measures.

7. The computer-implemented method of claim 5, further comprising:
determining, based on the respective local similarity measures, a peak similarity value;
determining whether the peak similarity value exceeds a peak threshold; and
upon a determination that the peak similarity value exceeds the peak threshold, associating the predicted defocus value with a high confidence level.

8. The computer-implemented method of claim 5, further comprising:
determining a curvature for the aggregated respective local similarity measures;
determining whether the curvature is within a curvature threshold; and
upon a determination that the curvature is within the curvature threshold, associating the predicted defocus value with a high confidence level.

9. The computer-implemented method of claim 8, further comprising:
receiving a plurality of image frames, each image frame comprising a respective pixel array;
determining whether a lens movement between a pair of successive frames exceeds a movement threshold, and
wherein the applying of the respective local DCC calibrations is performed based on a determination that the lens movement between the pair of successive frames exceeds the movement threshold.

10. The computer-implemented method of claim 9, further comprising:
determining that the lens movement between the pair of successive frames does not exceed the movement threshold;
determining a respective global similarity measure for each of the pair of successive frames; and
determining an aggregated similarity measure by aggregating the respective global similarity measures, and
wherein the predicting of the defocus value for PDAF is based on the aggregated similarity measure.

11. The computer-implemented method of claim 10, wherein the determining of the aggregated similarity measure is performed spatio-temporally.

12. The computer-implemented method of claim 11, wherein an ambient light for the scene is below a threshold brightness.

13. A computing device, comprising:
one or more processors; and
data storage, wherein the data storage has stored thereon computer-executable instructions that, when executed by the one or more processors, cause the computing device to carry out operations comprising:
receiving, by an image sensor of a camera of the computing device, a pixel array corresponding to phase-detection pixels for a preview of a scene to be captured by the camera;
subdividing at least a portion of the pixel array into a plurality of sub-regions;
applying, based on a respective local signal strength associated with each of the plurality of sub-regions, a respective local defocus conversion coefficient (DCC) calibration;
predicting, by stacking the respective local signal strengths that have respective applied DCC calibrations, a defocus value for phase-detection autofocus (PDAF); and
providing, based on the predicted defocus value, an adjustment to a lens position for the camera.

14. The computing device of claim 13, wherein the at least a portion of the pixel array comprises at least one region of interest (ROI), and wherein each of the plurality of sub-regions corresponds to a local ROI located within the at least one ROI.

15. The computing device of claim 13, wherein each of the respective local signal strengths is associated with a corresponding local lens position, and wherein the adjustment to the lens position is based on the local lens positions.

16. The computing device of claim 13, wherein the operations for the applying of the respective local DCC calibrations are performed prior to applying a subpixel interpolation technique.

17. The computing device of claim 13, wherein the operations for the applying of the respective local DCC calibrations comprise operations for determining respective local similarity measures for each of the plurality of sub-regions, and wherein the operations for stacking of the respective local signal strengths comprise operations for aggregating the respective local similarity measures.

18. The computing device of claim 17, the operations further comprising:
determining, based on the respective local similarity measures, a peak similarity value;
determining whether the peak similarity value exceeds a peak threshold; and
upon a determination that the peak similarity value exceeds the peak threshold, associating the predicted defocus value with a high confidence level.

19. The computing device of claim 17, the operations further comprising:
determining a curvature for the aggregated respective local similarity measures;
determining whether the curvature is within a curvature threshold; and
upon a determination that the curvature is within the curvature threshold, associating the predicted defocus value with a high confidence level.

20. The computing device of claim 19, the operations further comprising:
receiving a plurality of image frames, each image frame comprising a respective pixel array;
determining whether a lens movement between a pair of successive frames exceeds a movement threshold, and
wherein the applying of the respective local DCC calibrations is performed based on a determination that the lens movement between the pair of successive frames exceeds the movement threshold.

21. The computing device of claim 20, the operations further comprising:
determining that the lens movement between the pair of successive frames does not exceed the movement threshold;
determining a respective global similarity measure for each of the pair of successive frames; and
determining an aggregated similarity measure by aggregating the respective global similarity measures, and
wherein the predicting of the defocus value for PDAF is based on the aggregated similarity measure.

22. An article of manufacture comprising one or more non-transitory computer readable media having computer-readable instructions stored thereon that, when executed by one or more processors of a computing device, cause the computing device to carry out functions comprising:
receiving, by an image sensor of an image capture device, a pixel array corresponding to phase-detection pixels for a preview of a scene to be captured by the image capture device;
subdividing at least a portion of the pixel array into a plurality of sub-regions;
applying, based on a respective local signal strength associated with each of the plurality of sub-regions, a respective local defocus conversion coefficient (DCC) calibration;
predicting, by stacking the respective local signal strengths that have respective applied DCC calibrations, a defocus value for phase-detection autofocus (PDAF); and
providing, based on the predicted defocus value, an adjustment to a lens position for the image capture device.
